(19) United States
(12) Patent Application Publication
(10) Pub. No.: US 2021/0406957 A1
(43) Pub. Date: Dec. 30, 2021

(54) REAL-TIME IDENTITY ENRICHMENT AND DEFINITION WITH DIGITAL SMART SCREEN

(71) Applicant: ROAD RUNNER MEDIA, INC., Rancho Santa Margarita, CA (US)

(72) Inventors: CHRISTOPHER RILEY, COSTA MESA, CA (US); RANDALL LANHAM, COTO DE CAZA, CA (US); JEFFREY ANDERSON, CARLSBAD, CA (US); DAVID MAROHNIC, SAN CLEMENTE, CA (US)

(73) Assignee: ROAD RUNNER MEDIA, INC., RANCHO SANTA MARGARITA, CA (US)

(21) Appl. No.: 17/358,697

(22) Filed: Jun. 25, 2021

Related U.S. Application Data
(60) Provisional application No. 63/044,355, filed on Jun. 26, 2020.

(51) Int. Cl. G06Q 30/02; G06N 7/00

(52) U.S. Cl. CPC G06Q 30/0261; G06N 7/005; G06Q 30/0246; G06Q 30/0267

(57) ABSTRACT

Systems and methods include acquiring data using multiple sensors in conjunction with a Digital Media Smart Screen, combining the sensor data in real time with data from big-data aggregators, resulting in real-time enriched analytics for highly-granular advertising decisions on the Digital Media Smart Screen, effectiveness measurement of those advertisements, targeting advertisements to individuals within viewing distance of the Digital Media Smart Screen, and re-targeting those individuals later with the same Digital Media Smart Screen or other displays in the same advertising ecosystem.

### PRIORITY CLAIM

The present application claims priority to U.S. provisional patent application Ser. No. 63/044,355 filed Jun. 26, 2020, which is incorporated herein in its entirety by reference.

### FIELD

The present application relates to systems and methods for combining data from disparate sources in real time to identify, target and/or retarget audience members exposed to Digital Out-of-Home advertisements on an electronic display media platform or display device, e.g., a “smart screen.”

### BACKGROUND

Digital-Out-Of-Home advertising involves deploying digital displays, often network-connected, in public areas, allowing advertisements to be seen by many people at once, and changed frequently or on demand. This contrasts with static Out-Of-Home billboards that require significant effort to change. Static Out-Of-Home billboard technology is very old, and historically, companies have measured traffic (of vehicles or humans) at fixed locations over time to estimate average audience size and makeup to be able to place a derived value on advertising at a specific location.

Digital-Out-Of-Home advertising (DOOH) is evolving based on experiences acquired with personal computer and mobile phone measurement. By removing personally-identifiable-information (PII) from consistent and repeatable tracking cookies or advertising identities, data can be used to understand an individual's interests or socio-economic and other data that can lead that individual to a purchase without PII. That same data has been used to measure the effectiveness of advertising and to target & re-target an individual for advertising a particular product or service based on past behavior. Digital-Out-Of-Home is evolving very quickly to develop the same depth and richness of data coming from these traditional digital mediums.

New measurement systems are evolving such as using artificial intelligence to analyze video feeds to determine how many vehicles or humans are in the viewability cone of the display. Other systems are analyzing the locations of millions of phones and past behavior of the consumers carrying those phones to observe patterns such as where people who visit gymnasiums are likely to go when they leave. Each of these systems can err by counting objects that are not relevant, such as confusing a statue of a family of people with a true family, or by making untrue assumptions such as concluding that because a mobile device is nearby its owner can see a display, when in fact the owner is just inside a store facing away from the street. No single system has a completely accurate view of what is going on around it, and therefore services are evolving which combine data and apply modeling to increase the accuracy of the measurement and then applying other measurement systems to prove their effectiveness of their measurement and modeling. Most of these systems are providing rich data post-event—in other words, after a particular advertisement is displayed—typically a week or more later because of the numeric analysis required to process a high volume of data. Industry reports that 12 to 15% of the audience is surveyed by these methods, leaving advertisers less informed than they could be by more specific direct audience measurement in real time. Combining analysis of video feeds with big data to enrich descriptive identity information regarding audience members is not a real-time possibility today.

Because a lot of the big-data sources rely on location-based-services being enabled and opted in on specific applications executing on mobile devices, the audience data these companies have definitive access to is about 12-15% of the US population on average. Therefore, the data must be adjusted to extrapolate real audience data from a relatively small data sample. An example of a service that acquires and sells access to this data is Cubiq™. The data acquired by these services may sometimes be referred to as a “data lake” because of its sheer size and inclusiveness.

A new evolution in DOOH advertising is mobile-Digital-Out-Of-Home™ or mDOOH™ advertising. In mDOOH™ advertising, not only is the audience changing by the second, and the content can change in milliseconds, but the display is not in a fixed location—it is mobile in the sense that the display itself is in motion. In the most complex case, the future location of that display cannot be predicted accurately because the carrier on which the display is mounted has an unknown task to perform besides hosting a mDOOH display, and that task determines where the carrier will go next. Finally, equipment embedded within the smart screen or mDOOH carriers will acquire data in real time regarding audiences with proximity to the Digital Media Smart Screen. New technologies such as mDOOH lack tools for better characterizing identities or other parameters of audience members in view of mobile display screens.

It would be desirable, therefore, to develop new methods and other new technologies for DOOH and mDOOH, that overcomes these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

The present application discloses systems and methods to acquire accurate data about audiences in real time at the site of a Digital Media Smart Screen on a carrier, enabling a new way to define audiences in mobile and static Digital Out Of Home advertising with fidelity in real time. This is a fundamental measurement of audience capable of wide adoption in the DOOH industry for making local decisions on the best advertisement to play on a Digital Media Smart Screen in real time and measuring effectiveness of advertisements played, without the long delays associated with current measurement solutions.

In an aspect of the disclosure, in a system running on a carrier which presents human-readable content via a Digital Media Smart Screen, a method may include acquiring real-time sensor data providing probabilistic proximity and/or other defining characteristics of one or more individuals, sending the real-time sensor data to a network-connected server, wherein the server uses the real-time sensor data to select content for an audience with proximity to the smart screen.

In further aspects, the method may include the server changing the human readable content based on the characterization of the audience received from the Digital Smart Screen system.

The real-time sensor data may include a location of the carrier acquired through a location sensor on the carrier. The carrier may be fixed or mobile. The location sensor, camera, or other sensors may be located on, in, or in known geometric relation to a display of the Digital Smart Screen.

The real-time sensor data may include an MACID of the WI-FI network adapter of at least one of the one or more individuals. For example, the real-time sensor data may include a facial image acquired through a camera.

In another aspect of the method, at least one element of the real-time sensor data is passed through an anonymizer service before being sent to the network-connected server.

The method may be instantiated as non-transitory computer-readable media including program instructions, which when executed by at least one processor of the network-connected server and/or a client thereof causes the system, including the Digital Media Smart Screen and ancillary components of a system 100 to perform operations of the method as described.

As used herein, a “client” or “server” includes at least a computer processor coupled to a memory and to one or more ports, including at least one input port and at least one output port (e.g., a desktop computer, laptop computer, tablet computer, smartphone, PDA, etc.). A computer processor may include, for example, a microprocessor, microcontroller, system on a chip, or other processing circuit. As used herein, a “processor” means a computer processor.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements correspondingly throughout the specification and drawings.

FIG. 1 is a schematic diagram illustrating aspects of an environment and system for real-time identity enrichment using a digital media smart screen.

FIG. 2 is a schematic diagram illustrating an algorithm for making data correlations in a data lake.

FIG. 3 is a block diagram illustrating operations of a method for selecting content responsive to detected audience information for display on a Digital Media Smart Screen carried by a carrier.

FIGS. 4-5 are block diagrams illustrating optional operations of the method diagrammed in FIG. 3.

FIG. 6 is a conceptual block diagram illustrating components of an apparatus or system for selecting content responsive to detected audience information for display on a Digital Media Smart Screen carried by a carrier.

### DETAILED DESCRIPTION

Various aspects are now described with reference to the drawings. In the following description, for purposes of explanation, numerous specific details are set forth to provide a thorough understanding of one or more aspects. It may be evident, however, that the various aspects may be practiced without these specific details. In other instances, well-known structures and devices are represented in block diagram form to facilitate focus on novel aspects of the present disclosure. The disclosed embodiments are merely illustrative of the claimed systems and methods that may be embodied in various forms. This present technology is not limited to the exemplary embodiments set forth herein. Rather, these exemplary embodiments are provided so that this disclosure will be thorough and complete and will fully convey the scope of the present technology to those skilled in the art.

As used herein, “Digital Media Smart Screen” means an electronic display capable of displaying human-readable content, including advertisements, delivered in real time over a network, with additional functionality from onboard and nearby hardware and software as described herein for enriching identification of audience members and related functions. It may sometimes be referred to as a “Digital Smart Screen.” Likewise, “carrier” means an electro-mechanical system enabling the Digital Media Smart Screen to connect to servers over a network, and possibly move the screen from one place to another. The carrier may be mobile or immobile and includes any hardware and software required not included in the Digital Media Smart Screen to enable data collection and shuttling media for the Digital Media Smart Screen. Without limitation, the carrier might be a specially equipped light post, truck, passenger car, bus, semi-trailer, vehicle for transporting humans, helicopter, or any other object that is capable of supporting a Digital Media Smart Screen. A carrier may or may not be capable of motion; if it is a mobile carrier, the Digital Media Smart Screen is also in motion.

As used herein, “Roadrunner Stack” means a collection of hardware and software which cooperates to deliver content to the Digital Media Smart Screen, regardless of where it is implemented. Parts of the stack may exist in the Digital Media Smart Screen, or integrated with the carrier.

As used herein, “MACID” refers to a static identity of a networking hardware endpoint, such as the media access control address (MAC Address) common in IEEE802 networking protocols, including ethernet, WiFi and Bluetooth.

As used herein, “AI” means Artificial Intelligence which includes, without limitation, machine learning systems that have been trained to count objects of interest, and other algorithms that mimic human reasoning in analysis of data streams from sensors to reach probabilistic conclusions.

As used herein, “services server” means a server that communicates with equipment on the carrier to enable certain functions (e.g., services) of the present technology.

As used herein, “real time” means without added delay and within a period of 60 seconds or less, for example, within 0.1 second, 0.5 seconds, 1 second, 2.5 seconds, 5 seconds, or 10 seconds. “Real-time” is an adjective denoting an action performed by a processor in real time.

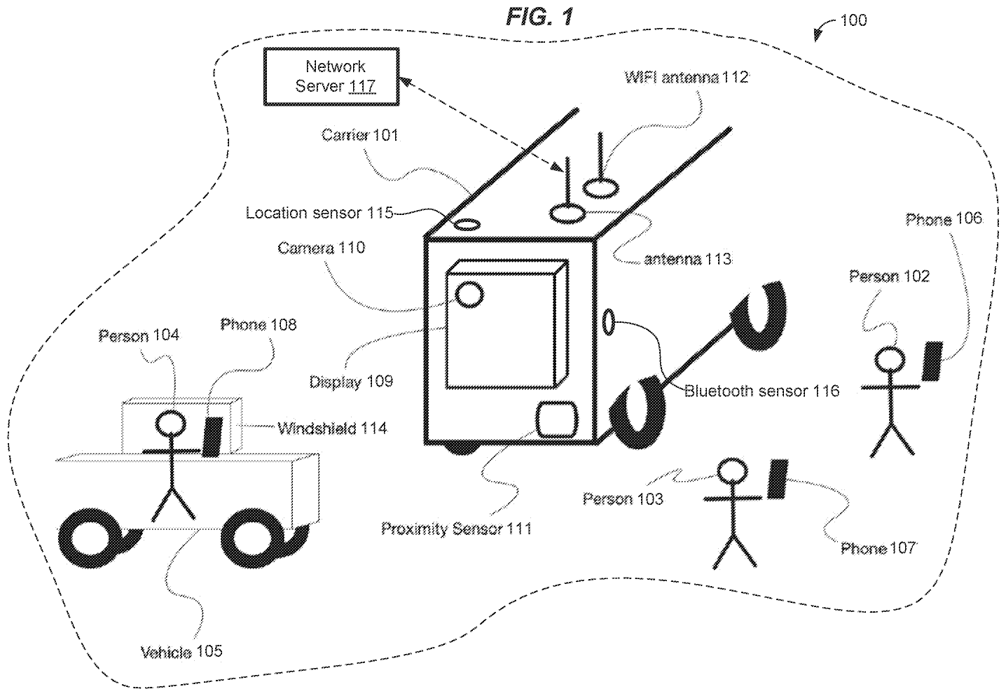

Referring to FIG. 1, a system 100 according to the present technology may include a combination of one or more sensors 110, 111 (e.g., camera 110 and proximity sensory 111) to acquire information about the real world where the carrier 101 is presently located, specifically to acquire probabilistic data about proximity of individuals 102, 103, 104 relative to a Digital Media Smart Screen 109. Specific embodiments may combine data from these or additional sensors in various ways to achieve higher fidelity results. The system need not know Personally Identifiable Information (PII) to accomplish its goals, but it will either know or learn about an identifier for each targeted audience member that can be used to know whether the member was somewhere earlier, and optionally, demographic and preference information for the audience member. The system 100 may include a cellular wireless, WiFi, or other antenna 113 with associated transceiver as known in the art for transmission and/or receipt of digital data to and from one or more services servers 117, also called network servers or remote servers.

The present technology in some embodiments includes a location sensor 115 to ascertain the location of the carrier 101 and/or Digital Media Smart Screen 109. Without limitation, the location sensor 115 may be, or may include, a GPS device, a GLONASS device, assisted GPS, WiFi triangulation, cellular telephone tower triangulation, hot spot proximity, and other location-acquiring sensors and systems that have yet to be deployed. The location sensor 115 may be placed on a carrier 101 even though the carrier is not inherently mobile, enabling consistency of display inventory and easing maintenance if the statically-deployed Digital Media Smart Screen is moved to a new location.

A system 100 according to the present technology in some embodiments may include a WiFi access point (WAP) capable of logging interactions with a Digital Media Smart Screen with antenna 112. Nearby mobile phones 106, 107, 108 with WiFi enabled will seek the WAP out and disclose information including the MACID of each nearby mobile phone's WiFi network adapter.

A system 100 according to the present technology in some embodiments may include a Bluetooth sensor 116, e.g., a receiver operating on a Bluetooth frequency. In certain situations, this leads to acquisition of an identity of the device in the form of a MACID of the Bluetooth adapter for mobile phones 106, 107, 108. Html content may be captured using technology as described in https://static.usenix.org/event/woot07/tech/full_papers/spill/spill_html/, which is incorporated by reference herein, with respect to use of a Bluetooth sensor.

A system 100 according to the present technology in some embodiments may use a video camera 110 positioned on or in known geometric relation to a Digital Media Smart Screen 109 in conjuction with AI to count human faces that are pointed in the direction of the display and close enough to be able to discern the content. In addition, or in an alternative, the video camera 109 and AI may be used to evaluate human faces through air or windshield 114 for demographic, mood and reaction data, ad/or to assign identifiers (e.g., numeric or pseudonymous identifiers) to human faces for tracking interactions by specific persons.

In another aspect, a system 100 according to the present technology may use a video camera and AI to count vehicles 105 (one of possibly many) that are pointed in the direction of the display 1009 and close enough to be able to discern content displayed or to be displayed on thereon.

In addition, a video camera 110 to read and interpret nearby vehicle license plates or identity numbers attached to machines transporting humans, including, without limitation, automobiles, buses, helicopters, airplanes, powered scooters, and bicycles—any perambulatory device. A related embodiment matches identity numbers seen with the Amber alert system and can notify authorities from a server which is receiving sensor data.

A system 100 according to the present technology in some embodiments may use a proximity sensor 111 on the carrier 101 to be able to detect and respond to a driver 104 following too closely by messaging instantaneously at a local level.

The carrier 101 may hold and move one or more Digital Media Smart Screens 109, each of which utilize an electronic display such as described in U.S. Pat. No. 9,934,709, which is incorporated in its entirety herein. The electronic display may receive content in a variety of ways, including, without limitation, from a content management system attached to a content delivery network, from a programmatic ad feed, or from an asynchronous push of data. The content is not limited to advertisements and may include VOI or PSA as described in U.S. Pat. No. 9,934,709. Because the carrier or the Digital Media Smart Screen 109 has multiple sensors, the complexity of decision making for content is increased, but so are the possibilities of what can be accomplished. The value of the images on the screen increases tremendously if the carrier is aware of the people who can observe it, in real time, whether in motion or at a static location.

By virtue of mobile carrier 101 deployment, considering proximity to humans along the carrier's travel route, the data acquired by the sensors can be quite large. The data so acquired may flow into the Roadrunner Media Data Lake.

Although each MACID is not guaranteed to be globally unique, most mobile device operating systems do not provide a means for the end user to change it. This is because if the MACID is not unique on the subnet that it resides on, routing errors will occur for the devices sharing that MACID. Therefore, allowing the user to change it raises reliability and security concerns. Since the user cannot change it, it might be considered Personally Identifiable Information, or PII. In contrast, the Advertising ID used by smart phone applications to track user behavior is under the control of the user in that he can opt out of being tracked by having his phone report zero (0) for the Advertising ID instead of a unique identifier, rendering tracking impossible.

A system 100 according to the present technology may include a way to bridge the gap of needing a unique MACID for network routing while allowing the end user control over privacy. In some embodiments, rather than sending the MACID into a tracking system, the MACID is hashed via a service before being sent to a tracking system. A simple application on a web page or other convenient method may be used to enable anybody to opt out of this tracking free of charge. As a web application, for example, the opt-out functionality is accessible to any internet-connected device with any modern browser. The system that anonymizes MACIDs is called the anonymizer service. The anonymizer service opt-out web page is called the opt-out webapp.

The persons 102, 103, 104, their respective phones 106, 107, 108 and the vehicle 105 illustrated in FIG. 1 may interact with the system 100 without being considered part thereof. Alternatively, the phones 106, 107, 108 and/or the vehicle 105 may include programmable electronic components integrated into the system 100.

The MACID of Bluetooth requires special handling because it is not readily visible to end users nor the protocol that communicates with the opt-out webapp.

The MACID is not the only sensor data that may be considered PII. Therefore, in some embodiments, certain sensor data is hashed through the anonymizer service. This may include, without limitation, facial images, automobile licenses, vehicle identifiers, and MACIDs. The opt-out webapp allows any supported and utilized data to be submitted, including without limitation a photograph, textual input to a form, or data sent from the device in a message requesting opt-out from the opt-out webapp.

An easy-to-explain use case is expected to include embodiments wherein the MACID of the WiFi network adapter of a mobile device is indicative of a unique individual. An MACID may be a proxy for a proven identity, because, among other things, a phone might be shared by family members. However, advertisers deal with this probability regularly today with the Advertiser ID in data lakes filled with data from opted-in smart phone location data sharing. In the case of the WiFi MACID, the carrier's WiFi access point detects the MACIDs of nearby mobile devices while the on-carrier Digital Media Smart Screen is presenting some specific content, which might be a specific advertisement. This data set may or may not be passed through the anonymizer service before being sent to a targeting service which may cause an event to be created on the carrier, changing the content of the display for the specific benefit of being seen by a specific individual who is capable of seeing the screen on the carrier collecting data via sensors. This occurs because the individual with that MACID is someone that has been previously identified as a person that might benefit from seeing that specific content. The event was possible because the MACID, directly or indirectly, is associated with other data that isn't PII, but is consistent and associated with that same person. This occurs through browser cookies, tracking pixels, Advertising ID sent in with location data from smart phone applications and other data that is being tracked today by other vendors and systems. Such data is aggregated but the sets can be queried for membership. In other words, these services can answer whether a specific data item such as a specific cookie exists in a collection of location data. A system according to the present technology may add identification proxy data to the association of information. It may do this through a lookup in another service, or it may track this through applications written by the operators of the systems deployed.

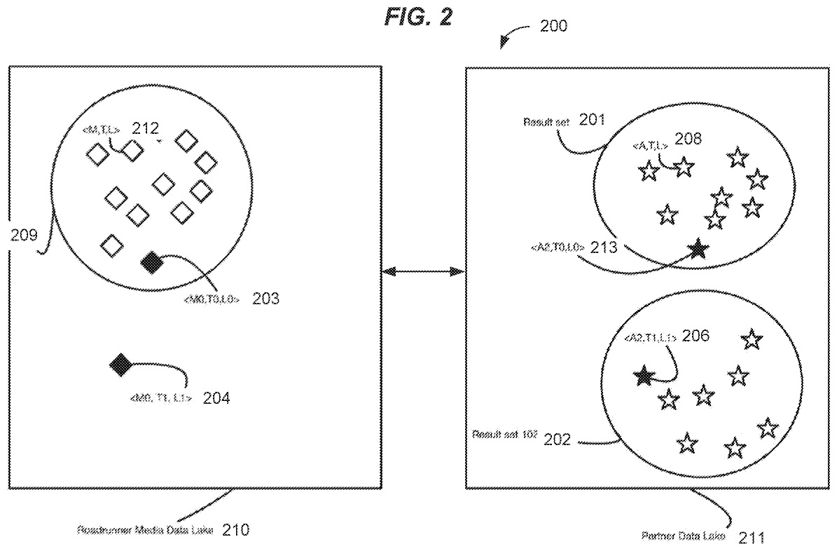

In some embodiments, a system according to the present technology may accumulate data in the Roadrunner Media Data Lake, which stores all this sensor data such that it is possible to learn the Advertising ID associated with any given MACID. Referring to FIG. 2, the system may search the Roadrunner Media Data Lake (RMDL) 210 for a plurality of data points 209 each containing a MACID, Time and Location tuple such as 212 in geographic proximity to a carrier at a specific point in time, then query a partner data lake (PDL) 211 containing data points 201 each containing (A)dvertising Ids, (T)ime and (L)ocation tuples such as 208. By noting during insertion of data points into the RMDL 210 how many times a MACID has been seen by the system, an on-the-fly decision is enabled about a MACID M0 of interest as shown by the <M0,T0,L0> tuple 203.

Then, using the time T1 and location L1 associated with a repeated MACID M0 in data point 204, the system may query the PDL for data extracted for a much smaller geographic area using the time T1 and location L1 in data point 204, creating result set 202. In FIG. 2, data points 213 and 206 both contain the same A2; this is the Advertising ID associated with the device with MACID M0, assuming, for example, it is the only data point in the result set 202 that is also in the result set 201. It is possible others are also in that set due to random chance or an affinity between phones, in which case more queries are needed using different times and locations. At some point, if multiple Advertising IDs are repeatedly associated with the same MACID, the present technology can draw the probabilistic conclusion that the devices belong to the same person, or at least two people who are very close. This could happen if the person carries a work and personal phone, or a tablet and a phone. It could also happen if a couple, each with their own phone, is on vacation together and they go everywhere together for several days. Regardless, it is probabilistically fair to associate the MACID to the one or more Advertising IDs for the purposes of the present disclosure.

Once the association between a MACID and an Advertising ID (or other similar future ID modalities) is generated using a method as explained above, these identifiers may be used equivalently in targeting. In some embodiments, the RMDL is not shared with partners. In some embodiments, query access to the RMDL could be sold. In some embodiments access to the RMDL could be through an API. In some embodiments access to the RMDL could be through a web application enabling the data to be reported and queried. In some embodiments the data itself could be sold.

In some embodiments, a camera backed by AI software that can convert the image of a vehicle license plate into a state and license plate number, for example California 3RRM007. The license plate is itself a probabilistic identity proxy for a human like a WiFi MACID—the car could be a rental car, or shared amongst family members, or an uber car carrying passengers all of which are showing up on the WiFi sensor. However, since the devices in the vehicle have a decent probability of showing up in the partner data lake (PDL) 211, the same deductions can be made for a vehicle license plate as for MACID. Once a vehicle is associated with one or more Advertising IDs, it can be used in other interesting ways.

In some embodiments, an advertising partner may place a camera with license plate recognition software on or in known geometric relation to a Digital Media Smart Screen such that measurement of advertising effectiveness can be richer. In other words, by knowing that a vehicle was behind the carrier when it was showing a particular advertisement, if the same vehicle shows up at the associated place of business in a statistically significant time frame after the ad was played, then the measurement of that ad effectiveness can be augmented. The recognition may be extended to other forms of identity, including, without limitation, identity markings on bicycles, scooters, ride share vehicles, boats, or other identified articles. Note that in this embodiment, no PII of the associated human was utilized.

In an aspect, license plate data so acquired may be used to query a database such as the Department of Motor Vehicles. In those databases today, those calls appear to return PII. The system may anonymize that data through the anonymizer, but in so doing it is not better than the license plate ID; if for privacy reasons in the RMDL we need to anonymize the plate itself, the system may do that from the plate data more readily. However, if services arise that return non-PII data from a license, returning the equivalent of an Ad ID, then the present technology could use that; so in some embodiments, after the license plate is recognized, the system may query a third party database to acquire data to use in further associations rather than the license plate number itself.

In some embodiments, an MACID may be shared with an advertising partner, or vice-versa. Advertising partners with brick-and-mortar stores which also have WiFi and smart phone applications are in a unique position to immediately and concretely associate a MACID to an Advertising ID. If the advertising partner shares that with Roadrunner Media, the association can be placed in the RMDL, optionally after anonymization. If the system detects an MACID capable of viewing the electronic screen, and that MACID is shared, un-anonymized, with the advertising partner, then if the advertising partner sees the device with that MACID in their store, they can use that data to measure effectiveness of that advertisement. There are a variety of means to do the effectiveness measurements, including A/B tests that are well known in the art.

In some embodiments, a camera on the carrier or embedded in the Digital Media Smart Screen may count objects such as vehicles and humans in proximity, or even passengers in the vehicles immediately behind the carrier. This data can be utilized to model real time audience data and verify or extrapolate data from the other sensors. As but one example, a count of the number of nearby persons can be utilized to determine advertising billing or select advertisements.

In some embodiments, the system may use technology as described in U.S. Pat. No. 9,934,709, which is incorporated by reference herein, to offer a safety value proposition. Many accidents with trucks involve rear-end collisions, often due to following too closely. The present technology in some embodiments utilizes a proximity sensor for safety, such that when a car follows too closely, the screen can immediately warn the driver in the vehicle behind that they are following too closely. Failure to heed the warning can cause the present technology to send a video of the vehicle for processing by Roadrunner Media safety personnel and potentially law enforcement. In this case it may make sense to acquire the PII of the driver through the DMV to contact him for safety purposes. This can be done automatically by the services server based on policy. The proximity sensor may be of any type as can be determined by one skilled in the art including a motion, optical or sound sensor.

Similarly, in some embodiments, the camera stream may be processed by AI software that can detect that the driver is looking down as opposed to forward at the road, as would be the case for a distracted driver watching a cell phone. To facilitate road safety, the display could be immediately changed to display a highly visible message regarding the dangers of texting and driving, or distracted driving in general. The display could flash that immediately, followed by a longer period involving a ‘don't text and drive’ banner which allows normal advertisements to play at the same time. As in the case where the driver is following too close, video can be submitted upstream to the services server for handling with safety personnel and/or law enforcement.

In another aspect, the system may use a front-windshield-penetrating camera to detect if a following vehicle is being driven by someone who is also texting or displaying distracted driving. Whereupon in real time a message on the Digital Media Smart Screen warns the driver to change behavior. A related embodiment then sends the photograph/vehicle registration data to law enforcement for follow up.

Any of the disclosed sensors may be located anywhere on the carrier 101, including inside the Digital Media Smart Screen 109. In the preferred embodiment, all the sensors are embodied in or attached to the screen, for ease of installation.

By combining these real-time, local proximity sensors with larger aggregated data from existing services, the Roadrunner Stack can create audience data on the fly and the media policy can make real-time decisions on which media to play. The Roadrunner Stack also includes reports on media effectiveness using this data.

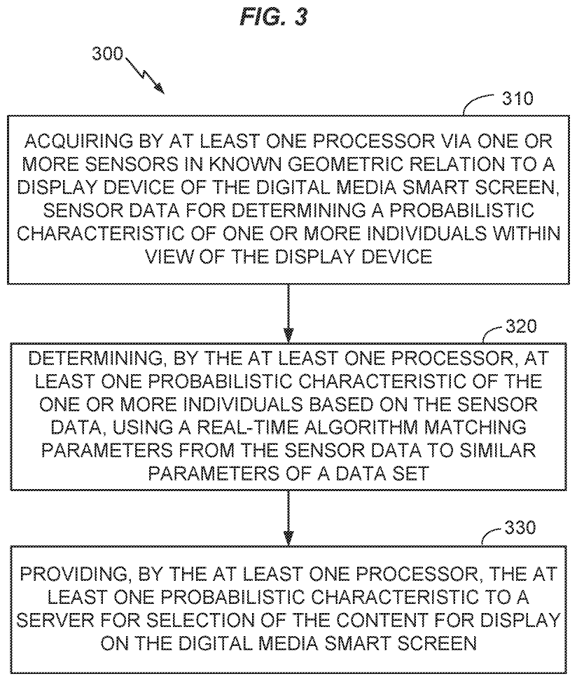

In accordance with the foregoing, and by way of additional example, FIGS. 3-5 show aspects of a method or methods 300 according to one embodiment, as may be performed by processors of a Digital Media Smart Screen and/or services server as described herein. It should be appreciated that the more general operations of method 300 may include or embody more detained aspects of corresponding methods described herein above.

Referring to FIG. 3, a computer-implemented method 300 for selecting content responsive to detected audience information for display on a Digital Media Smart Screen carried by a carrier may include, at 310, acquiring by at least one processor via one or more sensors in known geometric relation to a display device of the Digital Media Smart Screen, sensor data for determining a probabilistic characteristic of one or more individuals within view of the display device. The sensors may be fixed or movable so long as their geometric relation to the display screen is known to a precision high enough for determining whether the sensed individuals are in view of the screen. Individuals may be represented by larger objects, for example automobiles, presumed to contain them. The carrier may be movable or stationary. Real-time content selection for a movable carrier is enabled by the disclosed determination method.

The method 300 may further include, at 320, determining, by the at least one processor, at least one probabilistic characteristic of the one or more individuals based on the sensor data, using a real-time algorithm matching parameters from the sensor data to similar parameters of a data set. As used herein, the probabilistic score is not limited to a numeric indication of an individual probability, for example, “Individual X is 99% likely to be the same person shopping for a mobile phone at the Centerville Mobile Phone Shop last Tuesday at 11:35 AM.” In addition, or in an alternative, a probabilistic score may be inherently present as a threshold probability for enabling the following selection operation. The threshold may be fixed or variable. For example, the at least one processor may select the “most probable available” score as the threshold for application in selecting content, which will vary depending on available data. Regardless of how probability is expressed, the at least one processor determines a characteristic of the one or more proximate individuals. If several individuals are within visual range of the display, the processor may select one of the individuals for targeting, or a cohort thereof, using a prioritization algorithm. In any case, the at least one processor may follow the algorithm as described in connection with FIG. 2 hereinabove for determining the probabilistic characteristic.

The method 300 may further include, at 330, providing, by the at least one processor, the at least one probabilistic characteristic to a server for selection of the content for display on the Digital Media Smart Screen. Additionally, the method may include displaying the selected content to the one or more individuals by the Digital Media Smart Screen, once selected by the server.

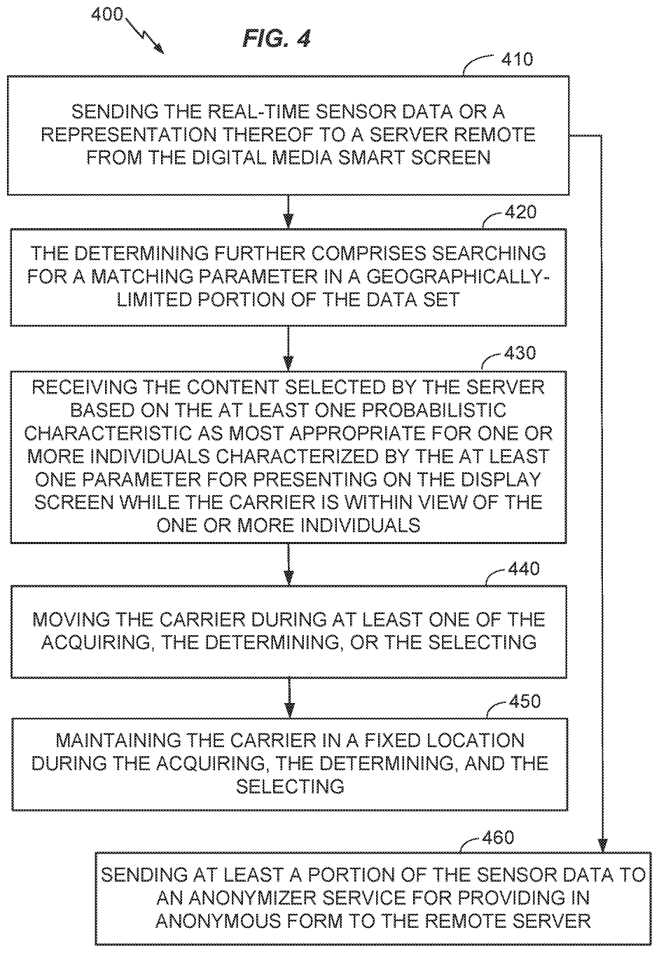

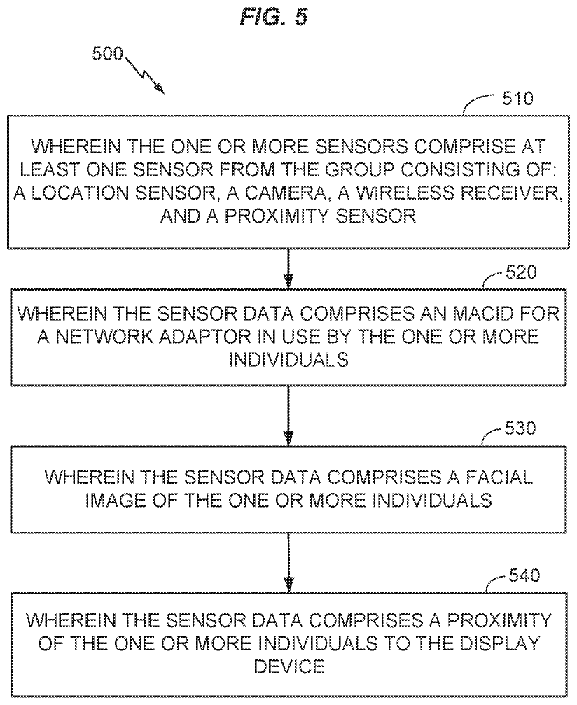

The method 300 may include any one or more additional operations as described above and below herein, including without limitation the additional operations 400, 500 described in connection with FIGS. 4 and 5. Each of these additional operations is not necessarily performed in every embodiment of the method, and the presence of any one of the operations does not necessarily require that any other of these additional operations also be performed. For example, optionally, method 300 may further include at 410 shown in FIG. 4, sending the real-time sensor data or a representation thereof to a server remote from the Digital Media Smart Screen, e.g., to a services server. The services server may process requests from multiple Digital Media Smart Screens mounted to different carriers. In addition, as shown at 460, the method 300 may further include sending at least a portion of the sensor data to an anonymizer service for providing in anonymous form to the remote server, for regulatory compliance or other privacy purpose.

Further with respect to the additional operations 400 shown in FIG. 4, the method 300 may include, at 420, performing the determining at least in part by searching for a matching parameter in a geographically limited portion of the data set, for example as described in connection with FIG. 2 above. The method 300 may include, at 430, receiving, by the at least one processor, the content selected by the server as most appropriate for one or more individuals characterized by the at least one parameter for presenting on the display screen while the carrier is within view of the one or more individuals, based on the at least one probabilistic characteristic. For example, for an individual recently shopping for a mobile phone, presenting an ad for a mobile phone. However, the present method and system are not limited to presentation of advertisements. The server selecting the content based on the at least one probabilistic characteristic may be remote from the Digital Media Smart Screen. In alternative embodiments, the server may be local, or incorporated as a component of the Digital Media Smart Screen.

At 440, the method 300 may include moving the carrier during at least one of the acquiring 310, determining 320, or selecting 330 operations of the method 300. For example, the carrier may be a motor vehicle displaying a screen. In addition, or in an alternative, the method 300 may include maintaining the carrier in a fixed location during the acquiring 310, determining 320, and selecting 330 of the method 300.

Referring to FIG. 5, the method 300 may include one or more of the additional operations 500. At 510, the method 300 may include using the one or more sensors including at least one of a location sensor, a camera, a wireless receiver, or a proximity sensor. At 520, the sensor data used in the method 300 may include an MACID for a network adaptor in use by the one or more individuals. At 530, the sensor data used in the method 300 may include a facial image of the one or more individuals. At 540, the sensor data used in the method 300 may include a proximity of the one or more individuals to the display device. The sensor data is not limited to these examples and relates generally to a parameter useful for targeting a display to the one or more individuals.

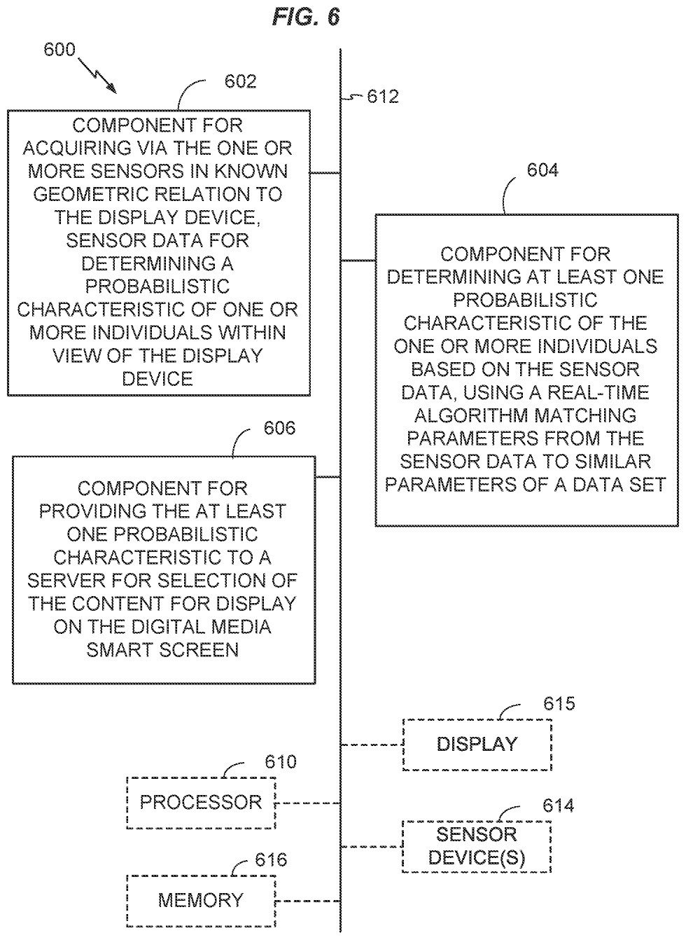

FIG. 6 is a conceptual block diagram illustrating components of an apparatus or system selecting content responsive to detected audience information for display on a Digital Media Smart Screen carried by a carrier as described herein, according to one embodiment. As depicted, the apparatus or system 600 may include functional blocks that can represent functions implemented by a processor, software, or combination thereof (e.g., firmware).

As illustrated in FIG. 6, the apparatus or system 600 may comprise an electrical component 602 for acquiring via one or more sensors 614 in known geometric relation to the display device 615, sensor data for determining a probabilistic characteristic of one or more individuals within view of the display device. The component 602 may be, or may include, a means for said acquiring. Said means may include the processor 610 coupled to the memory 616, and to the sensor device 614, the processor executing an algorithm based on program instructions stored in the memory. Such algorithm may include a sequence of more detailed operations, for example, initiating a communication session with the sensors device 614, receiving data via the communication session, characterizing the received data per an interface specification of the sensor device 614, and storing a characterized representation of the received data in a memory (e.g., random access memory) for later use.

The apparatus or system 600 may further comprise an electrical component 604 for determining at least one probabilistic characteristic of the one or more individuals based on the sensor data, using a real-time algorithm matching parameters from the sensor data to similar parameters of a data set. The component 604 may be, or may include, a means for said determining. Said means may include the processor 610 coupled to the memory 616, the processor executing an algorithm based on program instructions stored in the memory. Such algorithm may include a sequence of more detailed operations, for example, as described in connection with FIG. 2, or FIG. 4.

The apparatus or system 600 may further comprise an electrical component 606 for providing the at least one probabilistic characteristic to a server for selection of the content for display on the Digital Media Smart Screen, based on the at least one probabilistic characteristic. The component 606 may be, or may include, a means for said providing. Said means may include the processor 610 coupled to the memory 616, the processor executing an algorithm based on program instructions stored in the memory. Such algorithm may include a sequence of more detailed operations, for example, providing the at least one probabilistic characteristic to a transport layer, formatting the at least one probabilistic characteristic according to an applicable transport protocol, and transmitting the formatted data to an address for the server. The server may select the content by any suitable method, for example by ranking one or more probabilistic characteristics for the one or more individuals according to a priority scheme, selecting at least one of the characteristics based on the ranking, and filtering an index of available content based on the selected characteristic.

The apparatus 600 may optionally include a processor module 610 having at least one processor, in the case of the apparatus 600 configured as a data processor. The processor 610, in such case, may be in operative communication with the modules 602-606 via a bus 612 or other communication coupling, for example, a network. The processor 610 may initiate and schedule the processes or functions performed by electrical components 602-606.

In related aspects, the apparatus 600 may include a network interface module operable for communicating with a storage device over a computer network. The apparatus may further include a connection to at least one sensor device 614 and to at least one display device 615, both as described herein above. In further related aspects, the apparatus 600 may optionally include a module for storing information, such as, for example, a memory device/module 616. The computer readable medium or the memory module 616 may be operatively coupled to the other components of the apparatus 600 via the bus 612 or the like. The memory module 616 may be adapted to store computer readable instructions and data for effecting the processes and behavior of the modules 602-606, and subcomponents thereof, or the processor 610, or the method 300 and one or more of the additional operations 400, 500 or other operations described herein in connection with the method 300. The memory module 616 may retain instructions for executing functions associated with the modules 602-606. While shown as being external to the memory 616, it is to be understood that the modules 602-606 can exist within the memory 616.

The various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer or system of cooperating computers. By way of illustration, both an application running on a server and the server can be a component. One or more components may reside within a process and/or thread of execution and a component may be localized on one computer and/or distributed between two or more computers.

Program instructions may be written in any suitable high-level language, for example, C, C++, C#, JavaScript, or Java™, and compiled to produce machine-language code for execution by the processor. Program instructions may be grouped into functional modules, to facilitate coding efficiency and comprehensibility. It should be appreciated that such modules, even if discernable as divisions or grouping in source code, are not necessarily distinguishable as separate code blocks in machine-level coding. Code bundles directed toward a specific function may be considered to comprise a module, regardless of whether machine code on the bundle can be executed independently of other machine code. In other words, the modules may be high-level modules only.

Various aspects will be presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. As used herein, a “processor” encompasses any one or functional combination of the foregoing examples.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

The previous description of the disclosed aspects is provided to enable any person skilled in the art to make or use the present disclosure. Various modifications to these aspects will be clear to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for selecting content responsive to detected audience information for display on a Digital Media Smart Screen carried by a carrier, the method comprising:
acquiring by at least one processor via one or more sensors in known geometric relation to a display device of the Digital Media Smart Screen, sensor data for determining a probabilistic characteristic of one or more individuals within view of the display device;
determining, by the at least one processor in real time, at least one probabilistic characteristic of the one or more individuals based on the sensor data, using a real-time algorithm matching parameters from the sensor data to similar parameters of a data set; and
providing, by the at least one processor, the at least one probabilistic characteristic to a server for selection of the content for display on the Digital Media Smart Screen.

2. The method of claim 1, wherein the at least one processor comprises a processor of a remote server, and the method further comprises sending the real-time sensor data or a representation thereof to the server remote from the Digital Media Smart Screen.

3. The method of claim 1, wherein the at least one probabilistic characteristic comprises at least one parameter from the group consisting of an advertiser ID, a personal identifier, a device identifier, or a demographic characteristic for each of the one or more individuals, and the determining further comprises searching for a matching parameter in a geographically limited portion of the data set.

4. The method of claim 1, further comprising receiving, by the at least one processor, the content selected by the server as most appropriate for one or more individuals characterized by the at least one parameter for presenting on the display screen while the carrier is within view of the one or more individuals, based on the at least one probabilistic characteristic.

5. The method of claim 1, wherein the carrier is mobile.

6. The method of claim 1, wherein the carrier is in a fixed location.

7. The method of claim 1, wherein the one or more sensors comprise at least one sensor from the group consisting of: a location sensor, a camera, a wireless receiver, and a proximity sensor.

8. The method of claim 7, wherein the sensor data comprises an MACID for a network adaptor in use by the one or more individuals.

9. The method of claim 7, wherein the sensor data comprises a facial image of the one or more individuals.

10. The method of claim 1, wherein the one or more sensors are fixed relative to the Digital Media Smart Screen.

11. The method of claim 2, further comprising sending, by at least one processor, at least a portion of the sensor data to an anonymizer service for providing in anonymous form to the remote server.

12. An apparatus for selecting content responsive to detected audience information for display on a Digital Media Smart Screen carried by a carrier, the apparatus comprising at least one processor operatively coupled to a display device of a Digital Media Smart Screen, to one or more sensors, and to a memory holding program instructions that when executed by the at least one processor cause the apparatus to perform:
acquiring via the one or more sensors in known geometric relation to the display device, sensor data for determining a probabilistic characteristic of one or more individuals within view of the display device;
determining at least one probabilistic characteristic of the one or more individuals based on the sensor data, using a real-time algorithm matching parameters from the sensor data to similar parameters of a data set; and
providing the at least one probabilistic characteristic for selection of the content for display on the Digital Media Smart Screen.

13. The apparatus of claim 12, wherein the at least one processor comprises a processor of a server remote from the Digital Media Smart Screen, and the program instructions further comprise instructions for sending the real-time sensor data or a representation thereof to the server.

14. The apparatus of claim 12, wherein the at least one probabilistic characteristic comprises at least one parameter from the group consisting of an advertiser ID, a personal identifier, a device identifier, or a demographic characteristic for each of the one or more individuals, and the memory holds further program instructions for the determining at least in part by searching for a matching parameter in a geographically limited portion of the data set.

15. The apparatus of claim 12, wherein the memory holds further program instructions for receiving the content selected by the server as most appropriate for one or more individuals characterized by the at least one parameter for presenting on the display screen while the carrier is within view of the one or more individuals, based on the at least one probabilistic characteristic.

16. The apparatus of claim 12, wherein the carrier is mobile.

17. The apparatus of claim 12, wherein the carrier is in a fixed location.

18. The apparatus of claim 12, wherein the one or more sensors comprise at least one sensor from the group consisting of: a location sensor, a camera, a wireless receiver, and a proximity sensor.

19. The apparatus of claim 18, wherein the sensor data comprises an MACID for a network adaptor in use by the one or more individuals.

20. The apparatus of claim 18, wherein the sensor data comprises a facial image of the one or more individuals.

21. The apparatus of claim 12, wherein the one or more sensors are fixed relative to the Digital Media Smart Screen.

22. The apparatus of claim 12, wherein the program instructions are further configured for sending at least a portion of the sensor data to an anonymizer service for providing in anonymous form to the remote server.
